(19) United States
(12) Patent Application Publication
(10) Pub. No.: US 2007/0143141 A1
(43) Pub. Date: Jun. 21, 2007

(54) Integrated Clinical and Medication Reconciliation System

(75) Inventors: Paul Villasenor, Newark, DE (US); Joseph Piccerillo JR., Phoenixville, PA (US); Jane E. Marlatt, Linfield, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/608,016

(22) Filed: Dec. 7, 2006

Related U.S. Application Data
(60) Provisional application No. 60/829,067, filed on Oct. 11, 2006.
(60) Provisional application No. 60/751,003, filed on Dec. 16, 2005.

(51) Int. Cl. G06Q 10/00; G06Q 50/00

(52) U.S. Cl. 705/2

(57) ABSTRACT

An integrated clinical and medication reconciliation system includes a clinical information system incorporating a patient record management system and treatment order processing system. A medication reconciliation system incorporates a user interface providing a display image including a first image area identifying medications a patient is receiving following admission to a healthcare provider facility and a second image area indicating medications the patient received prior to admission to a healthcare provider facility and a third image area indicating a consolidated list of medications and enabling a user to individually select medications to be added from the first and second image areas to the third image area. An interface supports automatic communication of data representing the consolidated list of medications from the medication reconciliation system to the treatment order processing system.

This is a non-provisional application of provisional application Ser. No. 60/829,067 by P. Villasenor et al. filed Oct. 11, 2006 and provisional application Ser. No. 60/751,003 by P. Villasenor et al. filed Dec. 16, 2005.

### FIELD OF THE INVENTION

This invention concerns an integrated clinical and medication reconciliation system for reconciling treatments and medications of a patient received both prior to, and following admission to a healthcare provider facility.

### BACKGROUND OF THE INVENTION

A Joint Commission on Accreditation of Healthcare Organizations (JCAHO) Patient Safety Goal (2005) requires healthcare providers to accurately and completely reconcile medications (and treatments) across the continuum of care during the care of a patient. Medication reconciliation comprises taking a patient's home medication list (medications prior to admission) and comparing it to the patient's current active medication orders (or, in the case of admission, this may be the medications being considered for ordering), to create a new medication list upon admission or the next care setting or a discharge medication list for a patient to use at home.

Known reconciliation systems are typically either fully paper-based, a paper plus electronic hybrid, or a standalone electronic system. (The paper/electronic model involves printing a list of medications and then manually reconciling them on paper). Known systems that are entirely paper-based require a user to retrieve and/or transcribe lists of a patient's home medications and active medications. Such systems suffer from being time consuming, prone to transcription errors, prone to errors in medication prescribing as well as legibility errors. Systems that are a paper-electronic hybrid, which include handwritten medication orders regardless of implementation, are prone to the same errors but to a lesser degree depending on how much information is generated and printed. Standalone systems are not integrated, so any medication list produced needs to be re-entered into the hospital information system if an electronic list is desired. A system according to invention principles addresses these deficiencies and related problems.

### SUMMARY OF THE INVENTION

An integrated clinical and medication reconciliation system facilitates reconciliation of a patient's medications in the acute and other care settings and provides the ability to view two medication lists and reconcile them to a third list on-screen. An integrated clinical and medication reconciliation system includes a clinical information system incorporating a patient record management system and treatment order processing system. A medication reconciliation system incorporates a user interface providing a display image including a first image area identifying medications a patient is receiving following admission to a healthcare provider facility and a second image area indicating medications the patient received prior to admission to a healthcare provider facility and a third image area indicating a consolidated list of medications and enabling a user to individually select medications to be added from the first and second image areas to the third image area. An interface supports automatic communication of data representing the consolidated list of medications from the medication reconciliation system to the treatment order processing system without user re-entry of the data representing the consolidated list of medications.

### BRIEF DESCRIPTION OF THE DRAWING

FIG. 1 shows a Hospital or Clinical Information System (HIS) including an integrated medication reconciliation system, according to invention principles.

FIG. 2 shows a user interface display image provided by the medication reconciliation system for reconciling orders for medications, according to invention principles.

FIGS. 3 and 4 show user interface display images provided by the medication reconciliation system for reconciling discharge orders for medications, according to invention principles.

FIG. 5 shows a flowchart of a process used by an integrated clinical and medication reconciliation, according to invention principles.

### DETAILED DESCRIPTION OF THE INVENTION

A system according to invention principles reconciles two patient medication lists to create a third consolidated list. The system enables an on-screen, user friendly, integrated reconciliation process that displays relevant medication information at a glance and bypasses handwritten medications. Furthermore, physician ordered medications are automatically checked using a drug database to validate accuracy of a prescription and are provided to other parts of the system without additional work or setup. In contrast to known standalone systems such as a reconciliation system from HealthTek Software Solutions, Inc., the inventive system includes a medication reconciliation system advantageously integrated with a hospital information system (HIS) and/or clinical information system. Thereby data generated or used by the medication reconciliation system is shared with a patient record without additional interfacing or data translation. The integrated medication reconciliation and clinical information system processes discrete medication data to provide a reconciled medication list that is advantageously automatically communicated to an order processing system and to a pharmacy system and is used to generate outpatient prescriptions. The reconciled medication list is also electronically communicated to a retail pharmacy via an c-prescribing infrastructure, and displayed at any time for review.

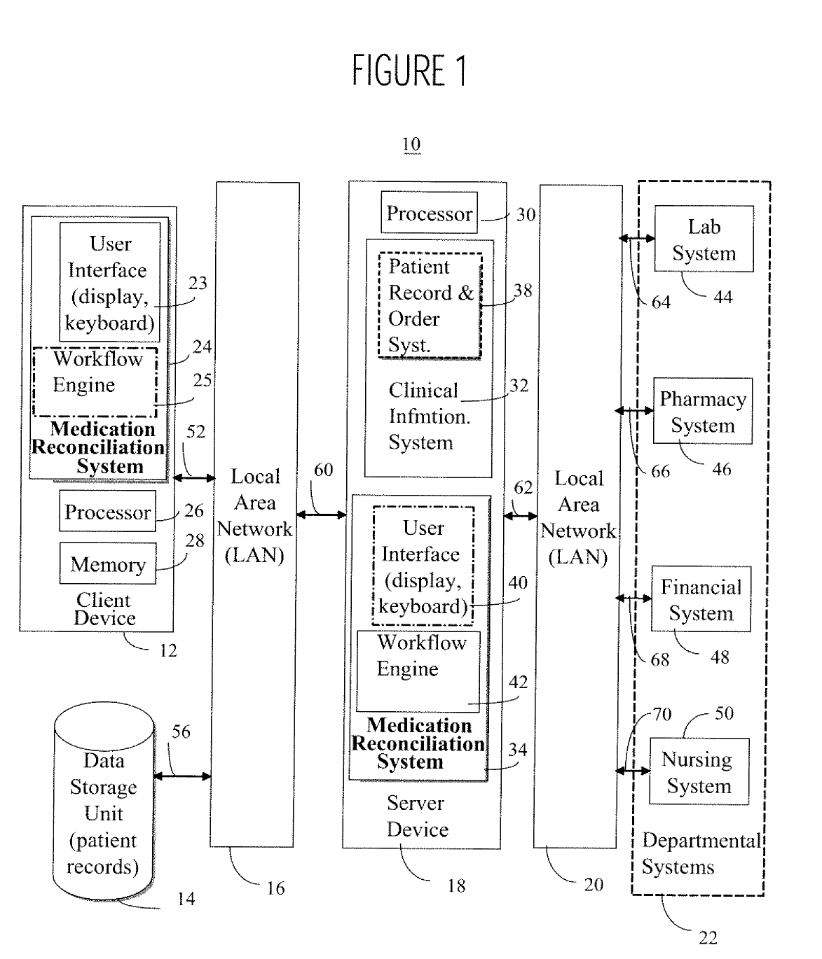

FIG. 1 shows a Hospital or Clinical Information System (HIS) 10 including an integrated medication reconciliation system. System 10 is used to perform medication reconciliation at patient admission, transfer or discharge and generates a consolidated (reconciled) medication list that becomes the patient's inpatient medications during a hospital stay or for transfer to another care setting or becomes a patient home medication list upon discharge. System 10 automatically initiates communication of reconciled medication orders directly to a pharmacy system via an order processing system. Further, at discharge, integrated system 10 advantageously both sends data indicating consolidated discharge medications to an e-prescribing system (or prescription printing system) and concurrently records a discharge medication list in a patient record without additional re-entry of data. This is in contrast to known standalone non-integrated systems that produce a hard copy document of patient medications that needs to be entered into a computerized treatment ordering system to order prescriptions and/or administration of the medications to a patient.

An executable application as used herein comprises code or machine readable instruction, that is compiled or interpreted, for implementing predetermined functions including those of an operating system, healthcare information system or other information processing system, for example, in response to user command or input, An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device and associated data acquisition and processing functions. A medication reconciliation system provides a consolidated (reconciled) list of patient medications from data indicating medications a patient received prior to inpatient admission and medications a patient is currently receiving, for example.

FIG. 1 shows a networked Hospital Information System (HIS) 10 including an integrated clinical and medication reconciliation system. In system 10, clinical information system 32 includes a patient record management system and treatment order processing system 38. Medication reconciliation system 34 incorporates user interface 40 providing a display image including a first image area identifying medications a patient is receiving following admission to a healthcare provider facility and a second image area indicating medications the patient received prior to admission to a healthcare provider facility and a third image area indicating a consolidated list of medications. The display image enables a user to individually select medications to be added from the first and second image areas to the third image area. Medication reconciliation system 34 includes an interface supporting automatic communication of data representing the consolidated list of medications from medication reconciliation system 34 to a medical record of the patient using patient record management system in unit 38 and to a treatment order processing system in unit 38 without user re-entry of the data representing the consolidated list of medications.

Medication reconciliation system 34 is used for reconciling active medication orders by providing a consolidated list of medications in response to a transition in patient care setting including, upon admission to a hospital, upon transition between different levels of care and service and upon discharge from a hospital. Medication reconciliation system 34 may alternatively be located in client device 12 as unit 24 (or elsewhere in a network employed by system 10). Medication reconciliation system 34 includes Rules Engine, Workflow Engine and task scheduler 42 and user interface 40. Client device 12, preferably implemented as a personal computer, also includes a processor 26, and a memory unit 28. Processor 26 and memory unit 28 are constructed and operate in a manner well known to those skilled in the art of the design of client devices.

Medication reconciliation system 24 in client device 12 includes corresponding workflow engine 25 and user interface 23. Medication Reconciliation system 34 employs structured user best practice rules in memory in clinical information system 32 that are automatically initiated when an Admission, Discharge and Transfer (ADT) or similar change of service or care setting of a patient occurs. System 34 reviews active medications of a patient in response to a change in care setting location of the patient so that dosage and method of administration of medication compatible with care setting medication administration rules are applied. System 34 documents changes in medications and associated dosages and methods of administration electronically by communicating data in HL7 transaction format to departmental systems 22, storage unit 14 and client device 12. System 10 maintains an audit record in unit 14 (or device 12) indicating changes made to patient medication in response to reconciliation performed using system 34 (with or without manual interaction). Medication reconciliation is typically performed in response to user interaction with the reconciliation system and user interface but in another embodiment may also be performed at least partially automatically.

Healthcare information system 10 generally includes a client device 12, a data storage unit 14, a first local area network (LAN) 16, a server device 18, a second local area network (LAN) 20, and departmental systems 22. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

User interface 40 in medication reconciliation system 34 generally includes an input device that permits a user to input information and an output device that permits a user to receive information. Preferably, the input device is a keyboard and mouse, but also may be a touch screen or a microphone with a voice recognition program, for example. The output device is a display, but also may be a speaker, for example The output device provides information to the user responsive to the input device receiving information from the user or responsive to other activity of the client device 12. For example, the display presents information responsive to the user entering information via the keyboard.

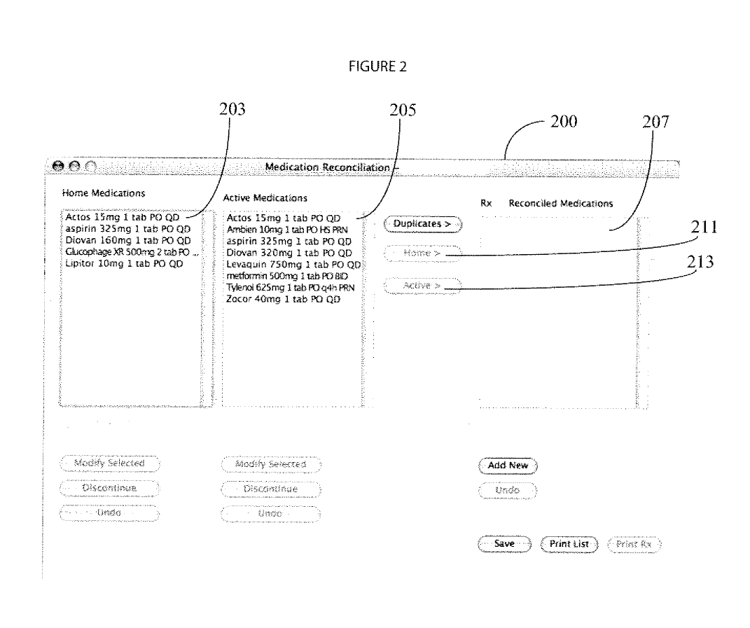

FIG. 2 shows a user interface display image provided by user interface 40 in medication reconciliation system 34 for reconciling orders for medications upon a patient care setting transition. User interface 40 provides display image 200 including first image area 203 identifying medications a patient received prior to admission to a healthcare provider facility (e.g., patient home medications) and a second image area 205 identifying medications a patient is receiving following admission to a healthcare provider facility (patient current inpatient medications or in the case of admission, the list of medications included in an admission medication order set) and a third image area 207 indicating a consolidated (reconciled, output) list of medications. Display image 200 enables a user to individually select medications to be added from the first and second image areas to the third image area via buttons 211 and 213 and supports user data entry to enter or update medication information (e.g., via an existing displayed area or in another embodiment, using a separate data entry image area). First image area 203 and second image area 205 may contain some of the same items.

User interface 40 and display image 200 of FIG. 2 and associated dialogs and menus supports performing medication reconciliation functions and enables a user to copy medication details from either source list in image areas 203 and 205 to the output list in image area 207 without modification. Display image 200 also enables a user to add a new medication (not on either source list) to the output list and to remove a indication added to the output list. A user interface 40 display image also enables a user to copy a medication in the source list and modify it before displaying it in the output list. For example, enable a user to select “aspirin 81 mg PO daily” in a source list and modify it to “aspirin 325 mg PO daily” before copying it into the output list. Display images provided by user interface 40 show medications already acted upon (“touched”) as highlighted or otherwise identified in the source lists (e.g., in image areas 203 and 205) and indicate a touched medication has not been carried over to the output list in area 207. Display images provided by user interface 40 also enable a user to record a reason for changing or not continuing a medication and to select a medication in a source list and highlight another medication in a source list with the same name but different dose, administration frequency or route.

Display images provided by user interface 40 also enable a user to select a medication in a source list and highlight another medication in another source list that is a brand or generic equivalent as well as to select a medication in a source list and highlight any medications in a source list that is in the same therapeutic class. User interface 40 also provides one or more display images supporting print of source lists before starting and a final output list and enables a user to record when the last dose of a selected medication was taken. The display images also enables a user to act on multiple source medications at once (either copy a medication group to an output list or show a group as touched but not copied to the output list) and shows a medication formulary status for patient insurance use.

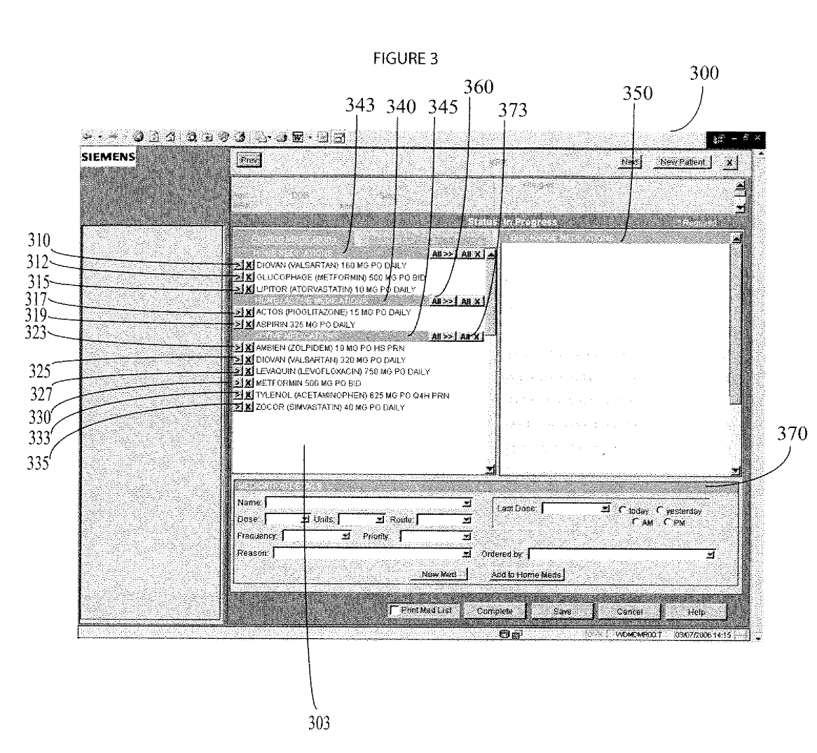

In another embodiment, the lists of image areas 203 and 205 may be consolidated in one image area showing the two lists along with medications common to both lists identified by visual attribute in similar fashion to a Venn diagram, for example. The image layout of such an embodiment eliminates the need for duplicate listings of medications and saves space involved in presenting replicated medication items. FIG. 3 shows a user interface display image provided by user interface 40 for reconciling discharge orders for medications. FIG. 3 exemplifies use of a single existing medication list in image area 303 identifying medications a patient received prior to admission to a healthcare provider facility and identifying medications a patient is receiving following admission to a healthcare provider facility and also indicating replicated items.

System 10 stores medication data as discrete data items (rather than free text) to facilitate performance of clinical checking (e.g., drug interaction, dosage and allergy checking) on a reconciled medication list as well as the communication of the reconciled medication list to an order entry or e-prescribing system. User interface 40 enables a user to enter data identifying new medications and in response to entered data, searches a database of medications (e.g. in unit 14 or 18) including prescription, over-the counter and herbal medications or may restrict a search to just the medications that are available in the hospital. The set of searchable medications depends on the setting, in which the system is being used. User interface 40 searches the medication database to enable a user to identify a medication for selection and entry and to verify safety of an entered medication by validating an entered medication, dose, frequency of administration and route of administration are consistent and suitable for the patient concerned.

Display image 300 (FIG. 3) illustrates medication reconciliation for a patient upon discharge from a hospital. Specifically, a patient in the hospital is being prepared for discharge, and as part of the discharge process, the physician reconciles patient medications by preparing a consolidated list of patient medications using system 34. Data indicating medications taken by a patient at home prior to admission is stored in system 10 (e.g., in data storage unit 14 or server unit 18) upon patient admission to the hospital. Similarly, data indicating medications currently being taken by the patient as an inpatient after admission is also stored in system 10. A physician employs medication reconciliation display image 300 and system 34 to compare patient home medications and current inpatient medications in generating a discharge medication list for the patient, In the example illustrated in display image 300, a patient has the following home medications Actos 15 mg PO daily (317), aspirin 325 mg PO daily (319), Diovan 160 mg PO daily (310), Glucophage 500 mg PO BID (312) and Lipitor 10 mg PO daily (315). In addition, the patient has the following current inpatient medications, Actos 15 mg PO daily (317), Ambien 10 mg PO HS PRN (323), aspirin 325 mg, PO daily (319), Diovan 320 mg PO daily (325), Levaquin 750 mg PO daily (327), metformin 500 mg PO BID (330), Tylenol 625 mg PO Q4H PRN (333) and Zocor 40 mg PO daily (335). PO indicates by mouth, BID indicates twice daily, PRN indicates as needed, HS indicates at bedtime, and Q4H indicates every four hours. The medications Actos 15 mg PO daily (317) and aspirin 325 mg PO daily (319) were both taken as a home medication and continued in the hospital as determined by medication reconciliation system 34 from stored medication history information of the patient. Display image 300 shows them under the “Home/Active” heading 340 and in neither the “Home” 343 nor “Active” 345 sections.

A physician employs display image 300 to reconcile the displayed medications by selecting and carrying the Actos and aspirin items 317, 319 to the Discharge Medications list 350 by selecting “All >>” button 360 in the “Home/Active Medications” section. The physician selects and carries over the Diovan 320 mg item 325 to the Discharge Medications list 350 by clicking the “>” button and marks the Diovan 160 mg item 310 as “not continued” by clicking the “X” button. Similarly, the physician selects and carries over the Glucophage item 312 to the Discharge Medications list 350 by clicking the “>” button and marks the metformin item 330 as “not continued” by clicking the “X” button. The physician also selects and clicks on the Lipitor item 315 and edits the dose in the Medication Details section 370 to be 20 mg and clicks a button to add the Lipitor item with the new dose to Discharge Medications list 350. The physician further selects and carries over the Levaquin item 327 as it is to the Discharge Medications list by clicking the “>” button and marks the remaining medications as “not continued” by clicking the “X” next to all unshaded medications or clicking “All X” button 373 in the “Active Medications” section 345.

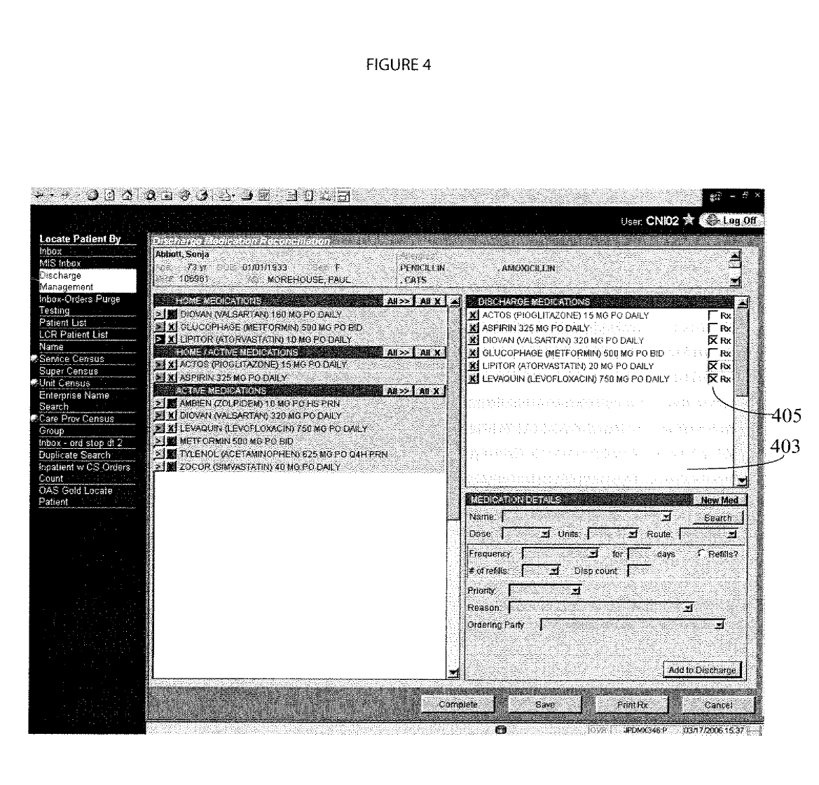

In response to completion of a discharge medication list using display image 300, a user selects the medications that need prescriptions and enters associated prescription details via dialogs and menus selected via image 300 in order to complete the prescriptions and initiates prescription printing. The FIG. 4 user interface image illustrates the results of medication reconciliation of discharge orders for medications. Specifically, image area 403 shows the Actos, aspirin, Diovan, Glucophage, Lipitor and Levaquin medications selected as discharge medications. Column 405 indicates Diovan, Lipitor and Levaquin are selected as medications designated for prescription printing.

Rules and workflow engine 42 identifies, duplicate, incompatible and replicated medications and conflicts between home and active medication lists by text comparison of medication names and codes. Engine 42 identifies, duplicate, incompatible and replicated medications and conflicts before a user manually performs reconciliation actions, during those actions and after a user has performed the manual reconciliation. The user is alerted to any such identification via a displayed user interface image alert message (or by another form of communication). Rules and workflow engine 42 also identifies different or incompatible methods of administration (routing) or incompatibilities with medication administration oules of a new healthcare facility. Replicated medications are indicated in a home/active section of a reconciliation display image (e.g., section 340 of FIG. 3) Rules and workflow engine 42 also performs a drug interaction check and a conflict check and performs administration review and verification. Engine 42 also uses medication code mapping information containing industry standard and other mapping information to support identifying duplicate or replicated medications. Engine 42 may employ a Common Vocabulary Engine in identifying duplicate or replicated medications. Medication code sets and identifiers used include HIPAA (Health Information Portability and Accountability Act) compatible code sets and other code sets used in a health care operation. Such code sets include, for example, ICD (International Classification of Diseases) codes, 9th Edition, Clinical Modification, (ICD-9-CM), Volumes 1, 2 and 3, as well as ICD-10 maintained and distributed by the U.S. Health and Human Services department. The code sets also include code sets compatible with HCPCS (Health Care Financing Administration Common Procedure Coding System), NDC (National Drug Codes), CPT-4 (Current Procedural Terminology), Fourth Edition CDPN (Code on Dental Procedures and Nomenclature). Further the code sets and terms include code sets compatible with SNOMED-RT “Systematicized Nomenclature of Medicine, Reference Terminology” by the College of American Pathologists, UMLS (Unified Medical Language System), by the National Library of Medicine, LOINC Logical Observation Identifiers, Names, and Codes Regenstrief Institute and the Logical Observation Identifiers Names and Codes (LOINC®) Committee, Clinical Terms also known as “Read Codes”, DIN Drug Identification Numbers, Reimbursement Classifications including DRGs (Diagnosis Related Groups). The code sets also include code sets compatible with CDT Current Dental Terminology, NIC (Nursing intervention codes) and Commercial Vocabulary Services (such as HealthLanguage by HealthLanguage Inc., by Apelon Inc.) and other code sets used in healthcare.

System 34 generates HealthLevel 7 (HL7) format compatible transaction messages conveying a reconciled (consolidated) new medication prescription list to other departmental systems 22. The other systems include a laboratory system 44, a hospital pharmacy system 46, a financial system 48 and a nursing system 50 and may further include an external pharmacy, a benefits administrator, an employer and other authorized systems (not shown to preserve drawing clarity). System 10 maintains an audit record in memory (e.g., in unit 14 or in device 18) indicating changes made to patient medication in response (with or without manual interaction) implementing industry best practices compatible with review organization (e.g., JCAHO) and national patient safety guidelines.

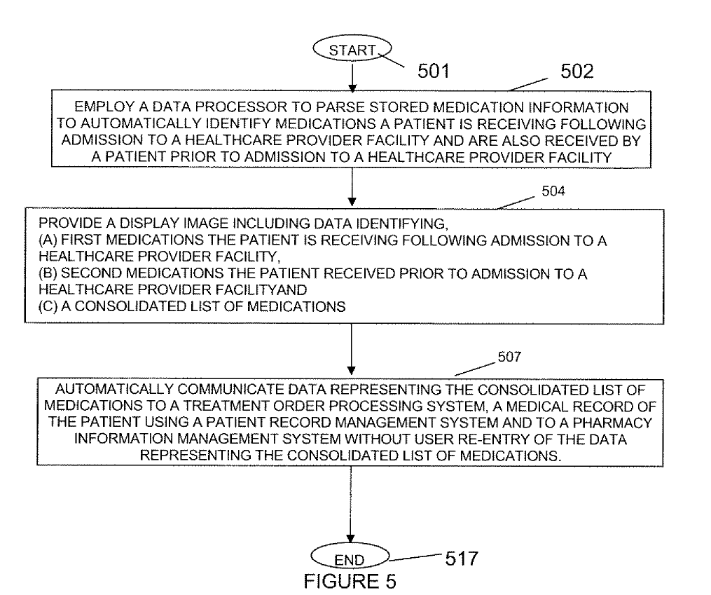

FIG. 5 shows a flowchart of a process used by medication reconciliation system 34 in reconciling orders for medications upon a patient care setting transition. The process begins in response to a patient moving to a new care setting. Besides physically moving a patient, the healthcare worker (Nurse, ward clerk as examples) records a transfer or a discharge into Hospital Information System (HIS) 10 using a computer workstation (client device 12) keyboard or mouse to select from a menu of transfer or discharge actions.

System 34 is preferably implemented in software, but may also be implemented in hardware or a combination of both. Further, any of the functions or activities performed by system 34 may be performed in response to user command in other embodiments. Data storage unit 14 stores patient records, as well as other information for the hospital information system 10. Patient records in the data storage unit 14 generally include any information related to a patient including, without limitation, biographical, financial, clinical, workflow, and care plan information.

The first local area network (LAN) 16 provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol. The communication paths 52, 56, 60, 62, 64, 66, 68 and 70 each may be formed as a wired or wireless (W/WL) connection.

FIG. 5 shows a flowchart of a process used by integrated clinical and medication reconciliation 10 including clinical information system 32 incorporating a patient record management system and treatment order processing system 38. In step 502 following the start at step 501, a data processor in medication reconciliation system 34 parses stored medication information to automatically identify medications a patient is receiving following admission to a healthcare provider facility and that are also received by the patient prior to admission to a healthcare provider facility. User interface 40 in medication reconciliation system. 34 in step 504 provides a display image. The display image includes data identifying, (a) first medications the patient is receiving following admission to a healthcare provider facility in a first image area, (b) second medications the patient received prior to admission to a healthcare provider facility in a second image area and (c) a consolidated list of medications in a third image area. Further, the display image enables a user to individually select from the first and second medications to add medications to the consolidated list of medications.

The first, second and third image areas in one embodiment, comprise different sections of one or more image windows or in a further embodiment, at least two different image windows. Also the third image area enables a user to automatically initiate automatic generation of a printed prescription and automatic communication of an electronic data file representing a printed prescription, for at least one of the medications on the consolidated list of medications. In addition, the display image includes data identifying medications common to both the medications the patient is receiving following admission to a healthcare provider facility and that are also received prior to admission to a healthcare provider facility.

In step 507, an interface in system 34 automatically communicates data representing the consolidated list of medications (or a particular medication and data comprising an electronic prescription for the particular medication for the patient) from medication reconciliation system 34 to a treatment order processing system in unit 38, a medical record of the patient using the patient record management system in unit 38 and to pharmacy information management system 46 (or to a remote pharmacy system external to a hospital), without user re-entry of the data representing the consolidated list of medications. The process of FIG. 5 terminates at step 517.

The system, process and image menus of FIGS. 1-5 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention, Functions, processes or activities connected with FIG. 1 and FIG. 5 may be performed automatically or alternatively, wholly or partially in response to manual interaction. A medication reconciliation system according to invention principles is applicable in other fields wherever the need exists to compare two lists and use them to generate a third and is advantageously used in the hospital setting by healthcare providers required to comply with pertinent safety regulations and guidelines, for example. Further, any of the functions and steps provided in the system of FIG. 1 may be implemented in hardware, software or a combination of both and may reside on one or more processing devices located at any location of a network linking the FIG. 1 elements or another linked network including another intra-net or the Internet.

What is claimed is:

1. An integrated clinical and medication reconciliation system, comprising:
a clinical information system including a patient record management system and treatment order processing system;
a medication reconciliation system incorporating a user interface providing a display image including a first image area identifying medications a patient is receiving following admission to a healthcare provider facility and a second image area indicating medications said patient received prior to admission to a healthcare provider facility and a third image area indicating a consolidated list of medications and enabling a user to individually select medications to be added from said first and second image areas to said third image area; and
an interface supporting automatic communication of data representing said consolidated list of medications from said medication reconciliation system to said treatment order processing system.

2. A system according to claim 1, wherein
said interface supports automatic communication of data representing said consolidated list of medications from said medication reconciliation system to said treatment order processing system without user re-entry of said data representing said consolidated list of medications.

3. A system according to claim 1, wherein
said interface supports automatic communication of said data representing said consolidated list of medications from said medication reconciliation system to a medical record of said patient using said patient record management system.

4. A system according to claim 1, wherein
said clinical information system includes a pharmacy information management system and
said interface supports automatic communication of said data representing said consolidated list of medications from said medication reconciliation system to said pharmacy information management system.

5. A system according to claim 4, wherein
said pharmacy information management system comprises a remote retail pharmacy information system.

6. A system according to claim 1, wherein
said clinical information system includes a pharmacy information management system and
said interface supports automatic communication of data representing a particular medication of said consolidated list of medications to said pharmacy information management system.

7. A system according to claim 6, wherein
said data representing said particular medication comprises an electronic prescription for said particular medication for said patient.

8. A system according to claim 1, including
a data processor for parsing stored medication information to automatically identify medications said patient is receiving following admission to a healthcare provider facility and are also received by said patient prior to admission to a healthcare provider facility wherein
said display image includes another image area identifying medications said patient is receiving following admission to a healthcare provider facility and are also received prior to admission to a healthcare provider facility.

9. A system according to claim 1, wherein
said first, second and said third image areas comprise different sections of one or more image windows.

10. A system according to claim 1, wherein
said first, second and said third image areas comprise at least two different image windows.

11. A system according to claim 1 wherein
said third image area enables a user to automatically initiate at least one of, (a) automatic generation of a printed prescription and (b) automatic communication of an electronic data file representing a printed prescription, for at least one of said medications on said consolidated list of medications.

12. An integrated clinical and medication reconciliation system, comprising:
a clinical information system including a patient record management system and treatment order processing system;
a medication reconciliation system incorporating a user interface providing a display image including a first image area identifying medications a patient is receiving following admission to a healthcare provider facility and a second image area indicating medications said patient received prior to admission to a healthcare provider facility and a third image area indicating a consolidated list of medications and enabling a user to individually select medications to be added from said first and second image areas to said third image area; and
an interface supporting automatic communication of data representing said consolidated list of medications from said medication reconciliation system to said treatment order processing system without user reentry of said data representing said consolidated list of medications and to a medical record of said patient using said patient record management system.

13. An integrated clinical and medication reconciliation system, comprising:
a clinical information system including a patient record management system and treatment order processing system;
a data processor for parsing stored medication information to automatically identify medications a patient is receiving following admission to a healthcare provider facility and are also received by said patient prior to admission to a healthcare provider facility;
a medication reconciliation system incorporating a user interface providing a display image including data identifying,
(a) first medications said patient is receiving following admission to a healthcare provider facility,
(b) second medications said patient received prior to admission to a healthcare provider facility and
(c) a consolidated list of medications, said display image enabling a user to individually select from said first and second medications to add medications to said consolidated list of medications; and
an interface supporting automatic communication of data representing said consolidated list of medications from said medication reconciliation system to said treatment order processing system without user reentry of said data representing said consolidated list of medications.

14. A system according to claim 13, wherein
said display image includes data identifying medications common to both said first and second medications comprising medications said patient is receiving following admission to a healthcare provider facility and are also received prior to admission to a healthcare provider facility.

15. A system according to claim 13, wherein
said interface supports automatic communication of data representing said consolidated list of medications to a medical record of said patient using said patient record management system.

16. A system according to claim 13, wherein
said display image enables a user to automatically initiate at least one of, (a) automatic generation of a printed prescription and (b) automatic communication of an electronic data tile representing a printed prescription, for at least one of said medications on said consolidated list of medications.
